(19) United States
(12) Patent Application Publication
(10) Pub. No.: US 2012/0023215 A1
(43) Pub. Date: Jan. 26, 2012

(54) DIGITAL SPACE MANAGEMENT SYSTEM

(75) Inventors: TSAO-TENG TSENG, TAIPEI (TW); CHI-WEN CHEN, TAIPEI (TW); YUNG-YANG CHIU, TAIPEI (TW)

(73) Assignee: LITE-ON TECHNOLOGY CORP., TAIPEI (TW)

(21) Appl. No.: 13/187,595

(22) Filed: Jul. 21, 2011

Related U.S. Application Data
(60) Provisional application No. 61/367,045, filed on Jul. 23, 2010.

(51) Int. Cl. G06F 15/173

(52) U.S. Cl. 709/223

(57) ABSTRACT

A digital space management system is provided for managing a plurality of peripheral devices in a space. The digital space management system includes a communication unit for communicating with the peripheral devices, and a processing unit electrically coupled to the communication unit. The processing unit is operable to generate a space management graphic interface with a floor-planning function and a room-planning function allowing a user of the digital space management system to perform a space planning operation for the space.

### CROSS-REFERENCE TO RELATED APPLICATION

This application claims priority of U.S. Provisional Patent Application No. 61/367045, filed on Jul. 23, 2010.

### BACKGROUND OF THE INVENTION

1. Field of the Invention

The present invention relates to a digital space management system for a plurality of peripheral devices, more particularly to a digital space management system for performing a space planning operation for a space and for managing a plurality of peripheral devices in the space.

2. Description of the Related Art

As communication technologies and digital household electrical appliances are developed increasingly, technologies for managing and controlling the digital household electrical appliances have been developed. For example, U.S. Pat. No. 7,627,098 discloses “an intelligent management apparatus and method of digital home network system” for minimizing user intervention and providing a relatively convenient living environment. However, the conventional technologies for managing and controlling the digital household electrical appliances do not provide a graphic interface allowing a user to perform a space planning operation for a space.

### SUMMARY OF THE INVENTION

Therefore, an object of the present invention is to provide a digital space management system for managing a plurality of peripheral devices in a space with the use of a graphic interface.

Accordingly, a digital space management system of the present invention is used for managing a plurality of peripheral devices in a space. The digital space management system comprises a communication unit for communicating with the peripheral devices, and a processing unit electrically coupled to the communication unit. The processing unit is operable to generate a space management graphic interface with a floor-planning function and a room-planning function for allowing a user of the digital space management system to perform a space planning operation for the space.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a space that has a plurality of peripheral devices and that is applied with a preferred embodiment of a digital space management system according to this invention;

FIG. 2 is a block diagram of the digital space management system of the preferred embodiment;

FIG. 3 is a schematic diagram illustrating a main menu graphic interface generated by the digital space management system of the preferred embodiment;

FIG. 4 is a schematic diagram illustrating a space management graphic interface generated by the digital space management system of the preferred embodiment;

FIG. 5 illustrates a space (home) catalog resulting from classification of space planning information according to floor information thereof;

FIG. 6 is a schematic diagram illustrating a device management graphic interface generated by the digital space management system of the preferred embodiment;

FIG. 7 is a schematic diagram illustrating the device management graphic interface associated with a device category of lighting equipment;

FIG. 8 illustrates a device function catalog resulting from functional classification of visual elements according to device function information of peripheral devices that respectively correspond to the visual elements;

FIG. 9 illustrates a device communication type catalog resulting from communication type classification of the visual elements according to communication type information of the peripheral devices;

FIG. 10 is a schematic diagram illustrating a home overview graphic interface generated by the digital space management system of the preferred embodiment; and

FIG. 11 is a schematic diagram illustrating a room view graphic interface generated by the digital space management system of the preferred embodiment.

### DETAILED DESCRIPTION OF THE PREFERRED EMBODIMENT

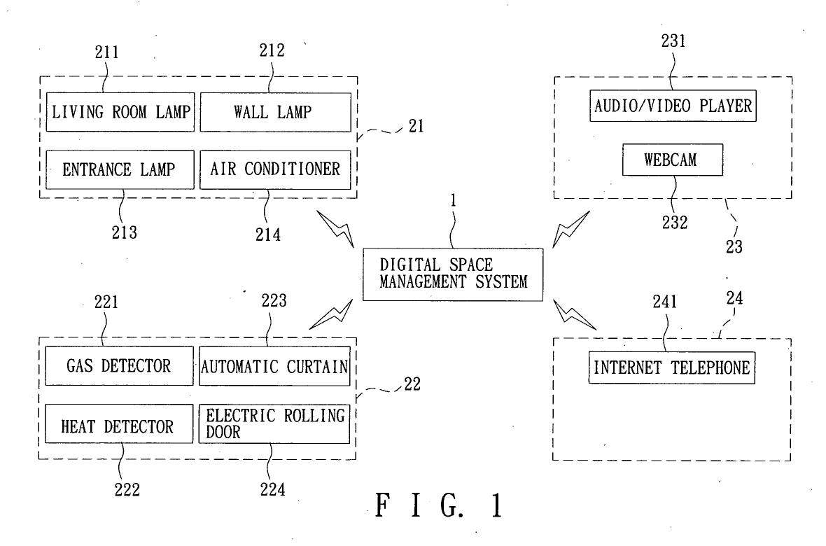

Referring FIG. 1, the preferred embodiment of a digital space management system 1 of this invention is applied to a space having a plurality of peripheral devices. In practice, the space may be a house, a hotel, a condominium, or a plan area and sub-spaces of an exhibition center or a large public space. For instance, the digital space management system 1 can be applied to management and control of peripheral devices in a house, to management and control of power source, lighting and air conditioning in an exhibition center, and to management and control of public facilities in a hotel or in a condominium. The digital space management system 1 is configured to manage and control the peripheral devices communicating with the digital space management system 1 via various communication types. As shown in FIG. 1, in this embodiment, the digital space management system 1 is applied to a house, and the peripheral devices in the house are classified, according to the communication types thereof, into an infrared communication-based device group 21, a Zigbee communication-based device group 22, a Wi-Fi communication-based. device group 23, and a Session Initiation Protocol (SIP) communication-based device group 24. The infrared communication-based device group 21 includes a living room lamp 211, a wall lamp 212, an entrance lamp 213, and an air conditioner 214.

The Zigbee communication-based device group 22 includes a gas detector 221, a heat detector 222, an automatic curtain 223, and an electric rolling door 224. The Wi-Fi communication-based device group 23 includes an audio/video player 231 and a webcam 232, The SIP communication-based device group 24 includes an internet telephone 241.

Currently, since intelligent household electrical appliances and network communication are developed increasingly, many home network protocol standards for regulating and controlling the peripheral devices have been developed. The digital space management system 1 is operable to control the peripheral devices through the existing home network protocol standards including, for example, LonTalk standard, ECONET standard, KNX standard, etc. Since the above-mentioned home network protocol standards are well known to those skilled in the art, details thereof will be omitted herein for the sake of brevity.

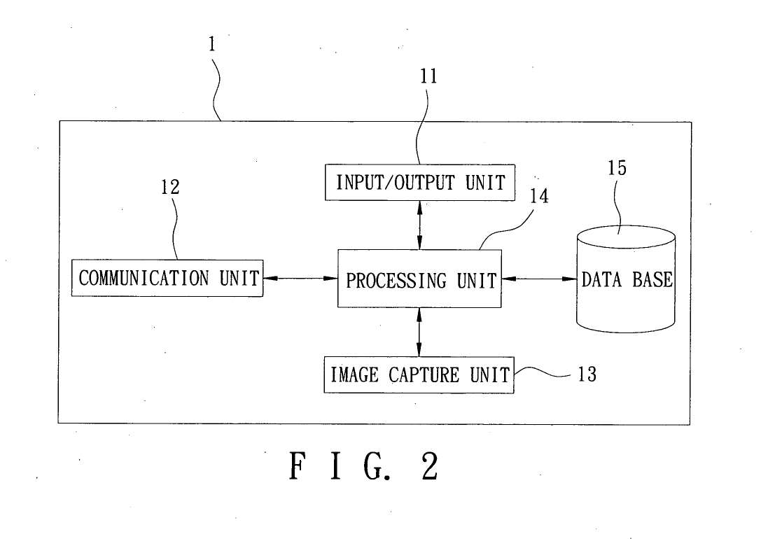

Referring to FIG. 2, in this embodiment, the digital space management system 1 is implemented with an electronic device, such as a portable electronic device examples of which include a smart phone, a personal digital assistant, a tablet computer, etc. The digital space management system 1 includes an input/output unit 11, a communication unit 12, an image capture unit 13, a processing unit 14, and a data base 15.

The input/output unit 11 is configured to allow a user to interactively operate the digital space management system 1. In practice, the input/output unit 11 is a combination of a keyboard, a mouse, a display and a joystick, a touch screen, or other devices with similar functions. The communication unit 12 is configured for communicating with the peripheral devices. The image capture unit 13 is configured for capturing a physical space image of the sub-space of the space. It should be noted that, in other embodiments, the image capture unit 13 may be omitted, and the physical space image may be captured by the webcam 232 and received by the communication unit 12 of the digital space management system 1 through wireless communication. In other embodiments, the image capture unit 13 and the webcam 232 may be configured to capture a physical space image of the space.

The processing unit 14 is electrically coupled to the input/output unit 11, the communication unit 12, the image capture unit 13 and the data base 15. During initialization of the digital space management system 1, the processing unit 14 is operable to detect and scan the peripheral devices through the communication unit 12 to obtain a plurality of device information sets corresponding to the peripheral devices, respectively. Further, the processing unit 14 is operable to store in the data base 15 the physical space image captured by the image capture unit 13 (or received by the communication unit 12 in other embodiments) and the device information sets.

In particular, each of the device information sets includes manufacturer information, device function information, communication type information, and device identification information. The manufacturer information has the information related to a manufacturer of a corresponding one of the peripheral devices, such as a name of the manufacturer. The device function information indicates a property of a function of a corresponding one of the peripheral devices, such as the functions of lighting, detection, temperature control, and communication. The communication type information indicates a communication type of a corresponding one of the peripheral devices, for example, Wi-Fi, infrared, and Zigbee. The device identification information is unique, and the digital space management system 1 is configured to identify a corresponding one of the peripheral devices through the device identification information.

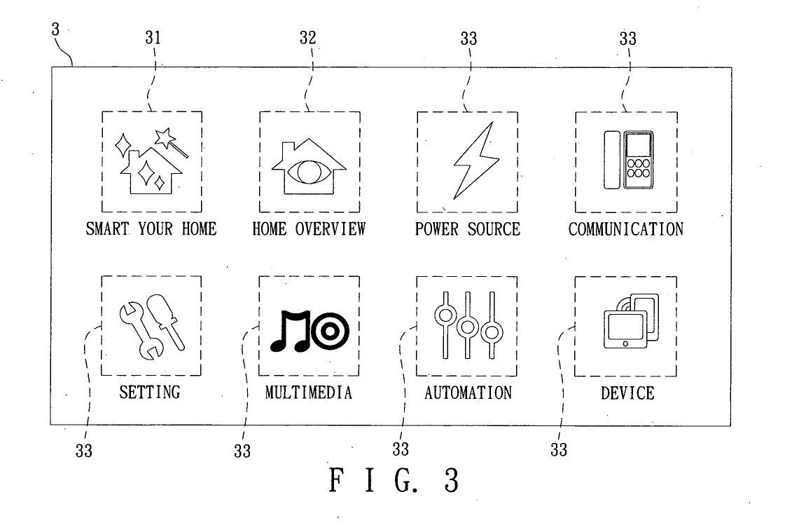

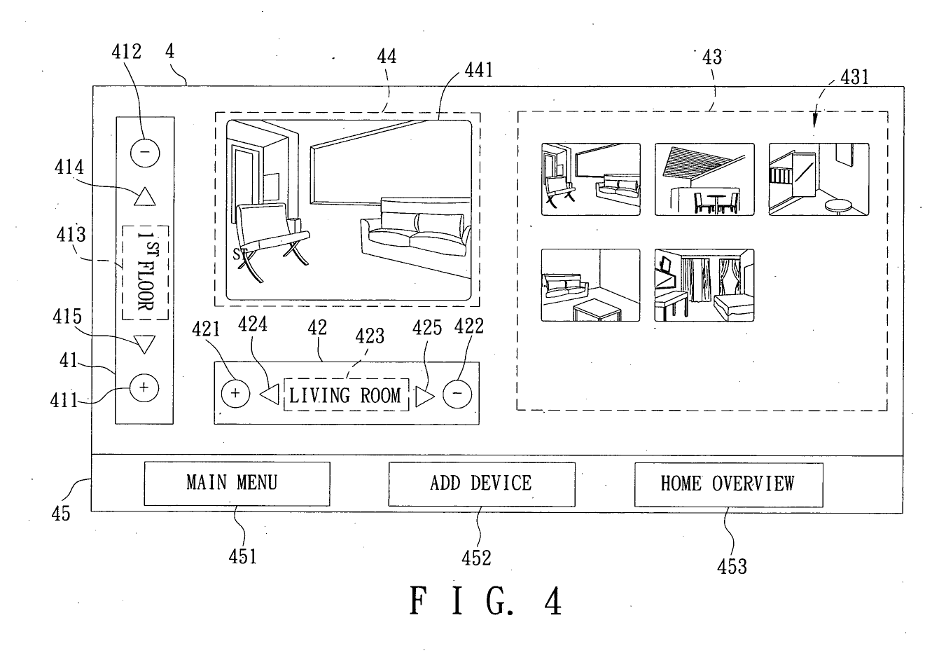

Referring to FIGS. 2 to 4, when the digital space management system 1 is activated, the processing unit 14 is operable to generate a main menu graphic interface 3 as shown in FIG. 3, and to control the input/output unit 11 to display the main menu graphic interface 3. The main menu graphic interface 3 includes a “Smart Your Home” icon 31, a “Home Overview” icon 32, and a plurality of function icons 33. When a user of the digital space management system 1 selects the “Smart Your Home” icon 31, the processing unit 14 is operable to generate a space management graphic interface 4 as shown in FIG. 4, to control the input/output unit 11 to show the space management graphic interface 4 to the user, and to allow the user to perform a space planning operation for the space, to set the physical space image of the sub-space, and to perform other interactive operations. In this embodiment, the space has at least one sub-space. In particular, the space is a house and the sub-space of the space is a room located in a floor of the house, and the physical space image is an image of the room. In the case of a space having only one sub-space, the sub-space may be a portion of the space or the space itself.

As shown in FIG. 4, an exemplary embodiment of the space management graphic interface 4 generated by the processing unit 14 includes a floor management toolbar 41, a room management toolbar 42, a first display area 43, a second display area 44, and a functional shortcut toolbar 45. The functional shortcut toolbar 45 includes a “Main Menu” button 451, an “Add Device” button 452, and a “Home Overview” button 953. When the user selects one of the buttons 451 to 453, the processing unit 14 is operable to control the input/output unit 11 to display a corresponding graphic interface allowing the user to perform a corresponding operation For example, when the user selects the “Main Menu” button 451, the processing unit 14 is operable to control the input/output unit 11 to display the main menu graphic interface 3 allowing the user to perform the interactive operation.

The floor management toolbar 41 in the space management graphic interface 4 generated by the processing unit 14 allows the user to perform a floor-planning function through the input/output unit 11. The floor management toolbar 41 includes a floor-adding button 411 for adding a floor to a space plan, a floor-deleting button 412 for deleting an existing floor from the space plan, a floor information display area 413 for displaying an index of a current floor that is to be planned in the space plan, an upward button 414 for changing the floor from the current floor to an upper floor in the space plan, and a downward button 415 for changing the floor from the current floor to a lower floor in the space plan. The room management toolbar 42 allows the user to perform a room-planning function through the input/output unit 11. The room management toolbar 42 includes a room-adding button 421 for adding a room to a floor plan, a room-deleting button 422 for deleting an existing room from the floor plan, a room information display area 423 for displaying a name of a current room that is to be planned in the floor plan, a previous button 424 for changing the room from the current room to a previous room in the floor plan, and a next button 425 for changing the room from the current room to a next room in the floor plan. The second display area 44 is configured to display the physical space image 441 associated with the current room with the name displayed in the room information display area 423.

When the user selects the room-adding button 421 to add a room to the floor plan during the space planning operation, the processing unit 14 is operable to display, on the first display area 43 in the space management graphic interface 4, the physical space images 431 (stored in the data base 15) of respective rooms that are located in a floor associated with the floor plan. Further, the processing unit 14 is configured to allow the user to use the input/output unit 11 for selecting one of the physical space images 431 on the first display area 43 that corresponds to a to-be-added room (i.e., the sub-space), and for dragging and moving the corresponding one of the physical space images 431 from the first display area 43 to the second display area 44 so as to set the physical space image 441 of the to-be-added room (the sub-space). The processing unit 14 is further operable, according to the space planning operation, to generate space planning information including floor information and room information, and to classify the space planning information according to the floor information and the room information.

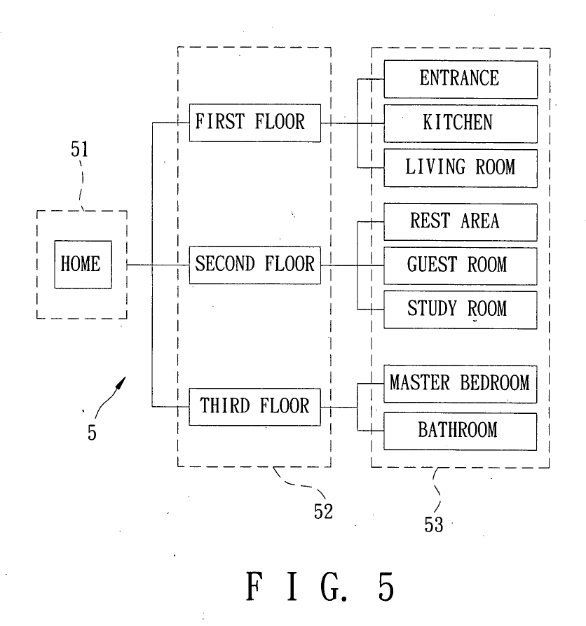

For example, it is assumed that, in the space planning operation, the user has planned the home with a first floor having a entranceway, a kitchen and a living room; a second floor having a rest area, a guest room and a study room; and a third floor having a master bedroom and a bathroom. The processing unit 14 is operable to classify the space planning information according to the floor information and the room information. The classification result is shown in FIG. 5 as a home catalog 5. In the home catalog 5, a root catalog 51 indicates the home, a first-layer sub-catalog 52 includes the described floors (i.e., the first to third floors) classified according to the floor information, and a second-layer sub-catalog 53 includes the described rooms corresponding to the respective floors in the first-layer sub-catalog 52.

Referring to FIGS. 2, 6 and 7, when the user selects the “Add Device” button 452 of the functional shortcut toolbar 45 shown in FIG. 4, the processing unit 14 is operable to generate a device management graphic interface 6, and to control the input/output unit 11 to display the device management graphic interface 6. The device management graphic interface 6 is configured to allow the user to perform a device disposing operation to dispose a plurality of visual elements in the physical space image 621. Each of the visual elements corresponds to a respective one of the peripheral devices, and may be an icon, an image or text in practice for indicating the respective one of the peripheral devices. The device management graphic interface 6 is further configured to display the described visual elements and to allow the user to perform interactive operation upon the peripheral devices.

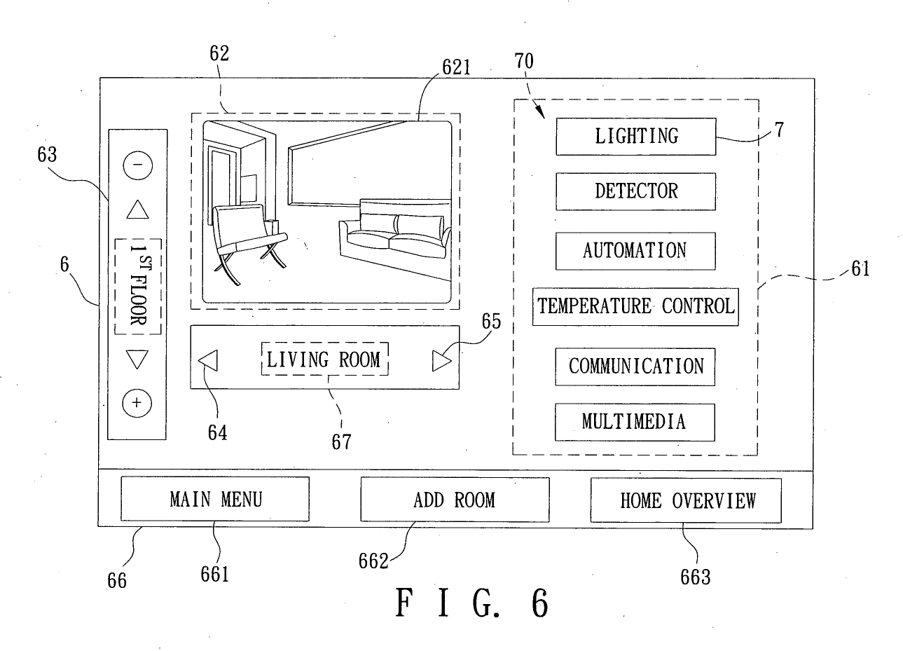

As shown in FIG. 6, an exemplary embodiment of the device management graphic interface 6 includes a third display area 61, a fourth display area 62, a floor management toolbar 63, a previous room button 64, a next room button 65, a functional shortcut toolbar 66, and a room information display area 67.

The third display area 61 is configured to display the visual elements corresponding to the respective peripheral devices. The fourth display area 62 is configured to display a physical space image 621 associated with the current room (i.e., the sub-space) that is to be planned and managed. Functions of the floor management toolbar 63 are similar to those of the floor management toolbar 41 in the space management graphic interface 4 of FIG. 4 for adding a floor to the space plan, for deleting an existing floor from the space plan, and for changing the current floor among various floors in the space plan. The previous room button 64 and the next room button 65 are configured to change the current room among various rooms in the floor plan associated with the same floor. The room information display area 67 is configured to display the name of the current room, i.e., the name of the room associated with the physical space image 621 displayed in the fourth display area 62. The functional shortcut toolbar 66 includes a “Main Menu” button 661, an “Add Room” button 662, and a “Home Overview” button 663. When the user selects the “Add Room” button 662, the processing unit 14 is operable to control the input/output unit 11 to display the space management graphic interface 4 shown in FIG. 4, and to allow the user to perform the space planning operation for the house (i.e., the space).

It should be noted that the device information sets of the respective peripheral devices are obtained by the processing unit 14 using the communication unit 12 to scan the peripheral devices during initialization of the digital space management system 1, and are pre-stored in the data base 15. The data base 15 is configured to further store a plurality of pre-established icons, and each of the device information sets further includes icon information indicating one of the pre-established icons stored in the data base 15. The processing unit 14 is operable to obtain one of the pre-established icons corresponding to one of the peripheral devices from the data base 15 according to the icon information in the device information set of the corresponding one of the peripheral devices, and to display said one of the pre-established icons of the corresponding one of the peripheral devices. Thus, the user can directly appreciate and know the peripheral devices actually corresponding to the visual elements, respectively.

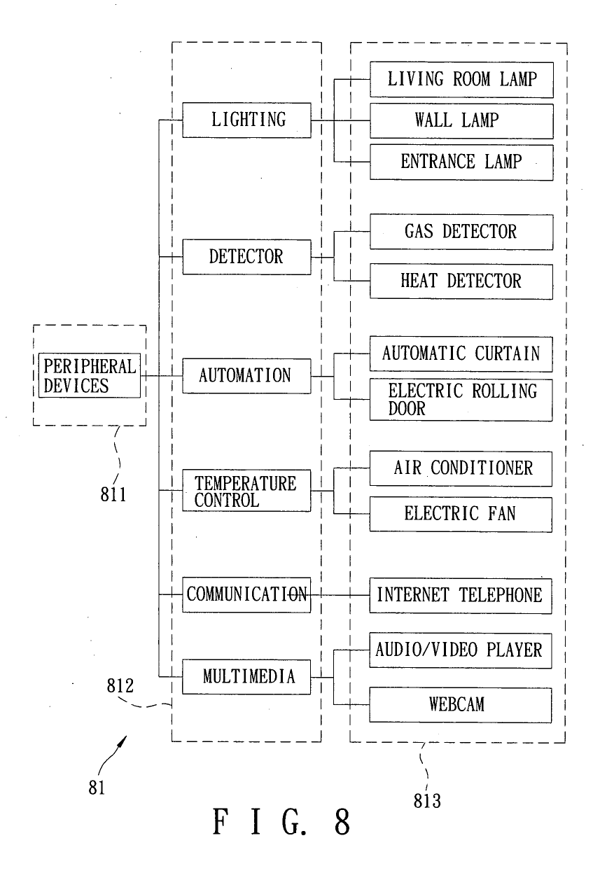

Further, the processing unit 14 is operable to classify the visual elements into various categories 70 according to the device information sets of the peripheral devices that respectively correspond to the visual elements, and to display the various categories 70 of the visual elements on the third display area 61. For example, the processing unit 14 is operable to classify the peripheral devices with the communication type of Zigbee according to standards in Zigbee Cluster Library (abbreviated as ZCL) of Zigbee pro 2007. In this embodiment, the processing unit 14 is operable to classify the peripheral devices into a category of lighting equipment, a category of detectors, a category of automation devices, a category of temperature control devices, a category of communication devices, and a category of multimedia devices. The result of the functional classification is shown in FIG. 8 as a device function catalog 81. In the device function catalog 81, a root catalog 811 indicates the peripheral devices, a first-layer sub-catalog 812 includes the described categories classified according to the device function information, and a second-layer sub-catalog 813 includes the peripheral devices classified into various groups each corresponding to a respective one of the categories in the first-layer sub-catalog 812.

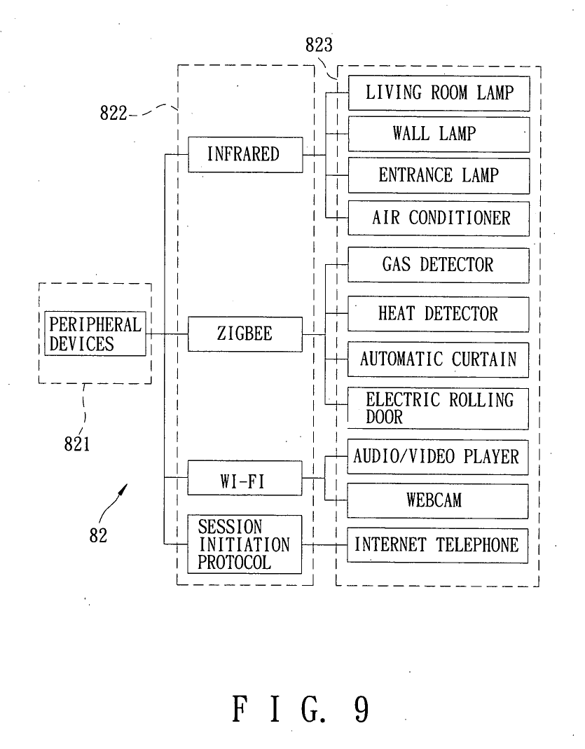

In other embodiments, the processing unit 14 may be operable, according to the communication type information, to classify the peripheral devices into a category of infrared devices, a category of Zigbee devices, a category of Wi-Fi devices, and a category of SIP devices. The result of the communication type classification is shown in FIG. 9 as a device communication type catalog 82. In the device communication type catalog 82, a root catalog 821 indicates the peripheral devices, a first-layer sub-catalog 822 includes the described categories classified according to the communication type information, and a second-layer sub-catalog 823 includes the peripheral devices classified into various groups each corresponding to a respective one of the categories in the first-layer sub-catalog 822.

When the user selects one of the categories 70 of the visual elements using the input/output unit 11, the processing unit 14 is operable to display the visual elements in the selected one of the categories 70 on the third display area 61. The visual elements are configured to allow the user to perform interactive operation upon the peripheral devices in the selected one of the categories 70. The processing unit 14 is further operable to generate at least one control signal in response to the interactive operation, and to send the control signal to a corresponding one of the peripheral devices through the communication unit 12.

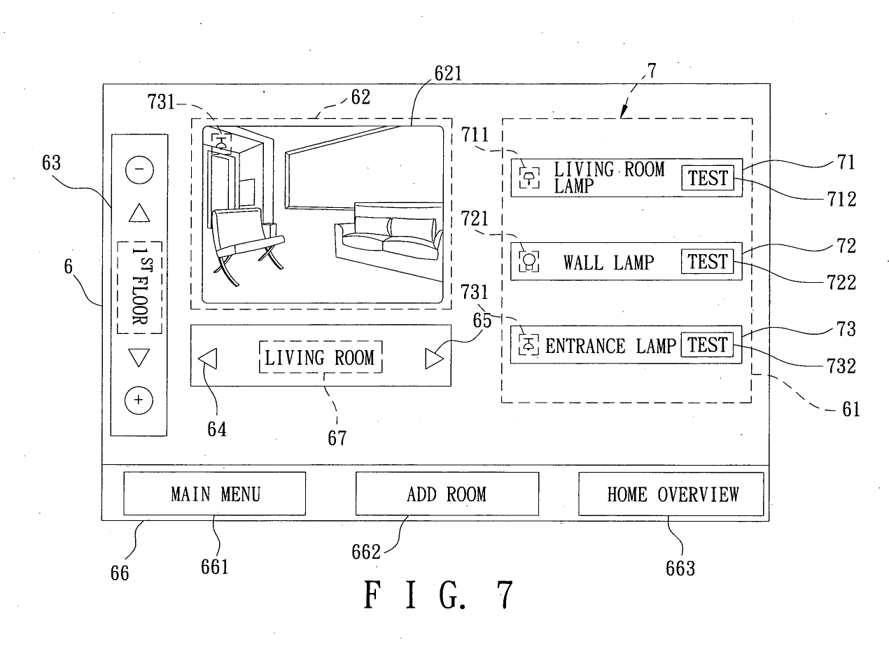

Referring to FIGS. 6 and 7 as an example, when the user touches the catalog of lighting equipment 7 (see FIG. 6), the processing unit 14 is operable to display a visual element of the living room lamp 71, a visual element of the wall lamp 72, and a visual element of the entrance lamp 73 on the third display area 61 in the device management graphic interface 6 as shown in FIG. 7. The visual element of the living room lamp 71 has an icon of the living room lamp 711 and a test button 712, the visual element of the wall lamp 72 has an icon of the wall lamp 721 and a test button 722, and the visual element of the entrance lamp 73 has an icon of the entrance lamp 731 and a test button 732. In this embodiment, when the user touches one of the test buttons 712, 722 and 732, the processing unit 14 is operable to check whether a corresponding one of the living room lamp 211, the wall lamp 212 and the entrance lamp 213 operates accordingly. The visual elements 71-73 in the third display area 61 are configured. to present a relatively bright color indicating that living room lamp 211, the wall lamp 212 and the entrance lamp 213 have not been allocated yet and can be disposed to a desired room.

As shown in FIG. 7, for disposing a visual element corresponding to a desired one of the peripheral devices (e.g., the entrance lamp 213), the device management graphic interface 6 generated by the processing unit 14 is further configured to allow the user to drag and move the icon 731 of the visual element 73 corresponding to the desired one of the peripheral devices (the entrance lamp 213) to the physical space image 621 displayed on the fourth display area 62. Then, the processing unit 14 is operable to generate, according to the device disposing operation, disposition information including a disposition relationship of at least one of the visual elements 71, 72, 73 in the physical space image 621. The disposition relationship indicates a position of one of the peripheral devices corresponding to said at least one of the visual elements 71, 72, 73 in the sub-space (i.e., the living room associated with the physical space image 621). In this embodiment, the disposition information further includes physical space information and device identification information of the peripheral devices corresponding to the respective visual elements that have been disposed in the physical space image 621. The physical space information is used for indicating the positions of the peripheral devices that have been disposed in the sub-space.

Seeing FIG. 7 as an example, after the user drags and moves the icon 731 corresponding to the entrance lamp 213 to the physical space image 621 on the fourth display area 62 associated with the living room using the input/output unit 11, the processing unit 14 is operable accordingly to generate the disposition information with the physical space information indicating that the entrance lamp 213 is in the living room on the first floor of the house. When the user touches the test button 732 of the visual element 73 corresponding to the entrance lamp 213 on the device management graphic interface 6, the processing unit 14 is operable to generate and send the control signal to the entrance lamp 213 according to the device identification information for checking whether the entrance lamp 213 operates accordingly. In this embodiment, the device management graphic interface 6 is further configured to allow the user to drag and move the icon 731 of the entrance lamp 213 from the physical space image 621 on the fourth display area 62 back to the third display area 61. At this time, the visual element 73 of the entrance lamp 213 in the third display area 61 is configured to re-present the relatively bright color indicating that the icon 731 of the entrance lamp 213 has not been allocated yet and can be disposed to a desired room. Similarly, after the user disposes the icon 731 of the entrance lamp 213 to the physical space image 621 on the fourth display area 62, the visual element 73 of the entrance lamp 213 in the third display area 61 is configured to present a relatively dim color indicating that the icon 731 of the entrance lamp 213 has been disposed.

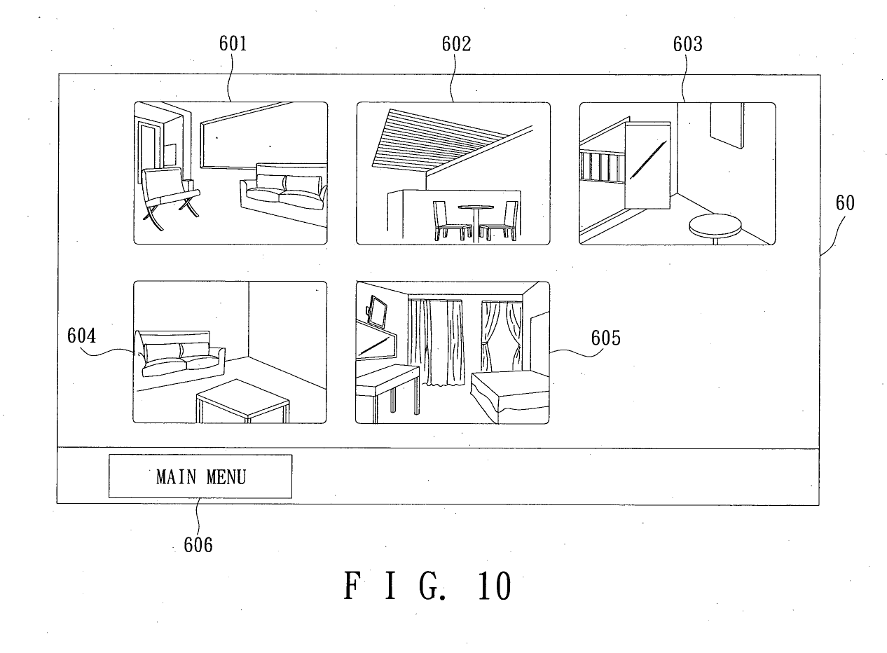

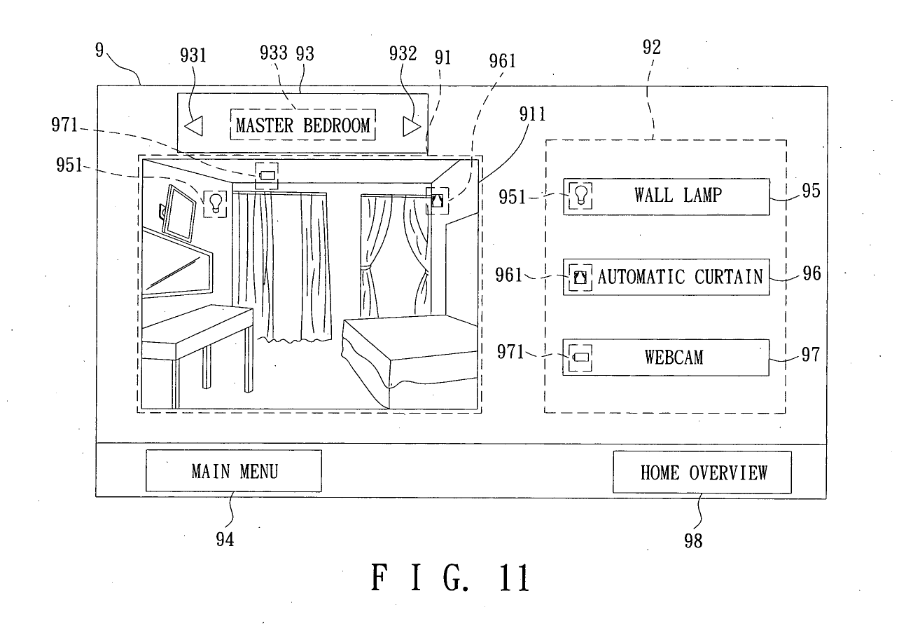

Referring to FIG. 10, when the user selects the “Home Overview” button 453 shown in FIG. 4 or the “Home Overview” button 663 shown in FIG. 6, the processing unit 14 is operable to generate a home overview graphic interface 60 for presenting the physical space images 601-605 that have been disposed with the visual elements after the space planning operation and the device disposing operation. When the user touches one of the physical space images 601-605, the processing unit 14 is further operable to generate a room view graphic interface 9 as shown in FIG. 11, and to control the input/output unit 11 to display the room view graphic interface 9 with a physical space image 911 corresponding to one of the physical space images 601-605 that has been touched in the home overview graphic interface 60. Further, the room graphic interface 9 is configured to allow the user to find the peripheral devices desired to be controlled from the physical space image 911 in the room view graphic interface 9 that has been allocated with the visual elements corresponding to the peripheral devices. Therefore, the u ser may control the peripheral devices by operating visual elements 95-97 in the room view graphic interface 9. The home overview graphic interface 60 includes a “Main Menu” button 606 for returning to the main menu graphic interface 3 as shown in FIG. 3.

As shown in FIG. 11, an exemplary embodiment of the room view graphic interface 9 includes a fifth display area 91, a sixth display area 92, a room toolbar 93, a “Main Menu” button 94, and a “Home Overview” button 98. When the user selects the “Home Overview” button 98, the input/output unit 11 is configured to display the home overview graphic interface 60 of FIG. 10 again. The fifth display area 91 is configured to display the physical space image 911 associated with a current room selected from the home overview graphic interface 60, and an icon 951 of the wall lamp 212, an icon 961 the automatic curtain 223, and an icon 971 of the webcam 232 that have been disposed to the physical space image 911. The sixth display area 92 is configured to display a visual element 95 of the wall lamp 212, a visual element 96 of the automatic curtain 223, and a visual element 97 of the webcam 232 that correspond to the peripheral devices disposed in the current room, respectively. The room, toolbar 93 includes a previous room button 931, a next room button 932, and a room information display area 933. The previous room button 931 and the next room button 932 are configured for changing the current room. The room information display area 933 is configured to display the name of the current room, i.e., the name of the room associated with the physical space image 911 displayed in the fifth display area 91.

In summary, the space management graphic interface 4 generated by the processing unit 14 is configured to allow the user to perform the space planning operation. The processing unit 14 is operable to generate the space planning information and to classify the space planning information according to the floor information such that the user may manage the space (i.e., the house) according to the home catalog 5. Further, the device management graphic interface 6 generated by the processing unit 14 is configured to allow the user to perform the device disposing operation to dispose the icons of the peripheral devices to the physical space images. The processing unit 14 is further operable to generate the disposition information according to the device disposing operation so as to provide the physical space information of the peripheral devices to the user.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A digital space management system for managing a plurality of peripheral devices in a space, said digital space management system comprising:
a communication unit for communicating with the peripheral devices; and
a processing unit electrically coupled to said communication unit, said processing unit being operable to generate a space management graphic interface allowing a user of said digital space management system to perform a space planning operation for the space.

2. The digital space management system as claimed in claim 1, the space having at least one sub-space,
wherein said processing unit is configured to generate the space management graphic interface to further allow the user to set a physical space image associated with the sub-space.

3. The digital space management system as claimed in claim 1, the space having at least one sub-space, wherein said processing unit is further operable to generate a device management graphic interface including a physical space image associated with the sub-space and a plurality of visual elements each of which corresponds to a respective one of the peripheral devices, and allowing the user to dispose at least one of the visual elements in the physical space image.

4. The digital space management system, as claimed in claim 3, wherein each of the visual elements allows the user to interactively operate the respective one of the peripheral devices, and said processing unit is further operable to generate at least One control signal in response to the interactive operation, and to send the control signal to a corresponding one of the peripheral devices through said communication unit.

5. The digital space management system as claimed in claim 3, wherein said processing unit is further operable to generate, according to the disposition of said at least one of the visual elements, disposition information including a disposition relationship of said at least one of the visual elements in the physical space image, the disposition relationship indicating a position of one of the peripheral devices corresponding to said at least one of the visual elements in the sub-space.

6. The digital space management system as claimed in claim 5, wherein the disposition information further includes physical space information and device identification information of the peripheral devices corresponding to the respective visual elements that have been disposed in the physical space image.

7. The digital space management system as claimed in claim 6, the space further having at least one floor, the sub-space being a room located in the floor of the space and the physical space image being an image of the room,
wherein the physical space information includes the floor and a position where the room is located in the floor.

8. The digital space management system as claimed in claim 7, wherein said processing unit is operable to generate the space management graphic interface further with a floor-planning function allowing the user to plan the floor in the space.

9. The digital space management system as claimed in claim 8, wherein said processing unit is further operable to generate space planning information including floor information according to the space planning operation, and to classify the space planning information according to the floor information.

10. The digital space management system as claimed in claim 3, the sub-space being a room located in the space,
wherein said processing unit is operable to generate the space management graphic interface with a room-planning function allowing the user of said digital space management system to plan the sub-space.

11. The digital space management system as claimed in claim 3, further comprising an input/output unit electrically coupled to said processing unit, wherein
the device management graphic interface generated by said processing unit is configured to allow the user to drag and move the visual elements through said input/output unit for disposing at least one of the visual elements in the physical space image; and
the device management graphic interface and the space management graphic interface generated by said processing unit are displayed on said input/output unit.

12. The digital space management system as claimed in claim 3, wherein said processing unit is further operable to detect and scan the peripheral devices through said communication unit to obtain a plurality of device information sets corresponding to the peripheral devices, respectively.

13. The digital space management system as claimed in claim 12, wherein said processing unit is further operable to classify the visual elements into various categories according to the device information sets of the peripheral devices that respectively correspond to the visual elements, and to display the visual elements according to the categories.

14. The digital space management system as claimed in claim 13, wherein the device information set of each of the peripheral devices includes device function information and communication type information.
